(19) United States
(12) Patent Application Publication
(10) Pub. No.: US 2014/0067318 A1
(43) Pub. Date: Mar. 6, 2014

(54) INCLINATION DETERMINATION SYSTEM

(71) Applicant: Paul Russell Friend, Morton, IL (US)

(72) Inventor: Paul Russell Friend, Morton, IL (US)

(73) Assignee: Caterpillar Inc.

(21) Appl. No.: 13/599,612

(22) Filed: Aug. 30, 2012

(51) Int. Cl. G01C 9/00; G06F 15/00

(52) U.S. Cl. 702/154

(57) ABSTRACT

An inclination angle determination system for determining an inclination angle of a machine is disclosed. The inclination angle determination system may have an inclinometer, an accelerometer, and a controller. The controller may be configured to determine the inclination angle by receiving inclination data from the inclinometer and derived inclination data based on acceleration data from the accelerometer. The controller may compare the inclination data and the derived inclination data, and may determine which of the inclination data and the derived inclination data to use as the inclination angle of the machine based on the comparison.

### TECHNICAL FIELD

The present disclosure relates generally to an inclination determination system, and more particularly, to an inclination determination system which maintains accuracy under vibrations.

### BACKGROUND

Machines such as, for example, dozers, motor graders, wheel loaders, wheel tractor scrapers, and other types of heavy equipment are used to perform a variety of tasks. Completing some of these tasks may require operation on or near inclines that, if inappropriately traversed by a machine, have the potential to roll the machine over, resulting in equipment damage and possible injury to the operator. When under the direct control of a human operator, the possibility of rollover may be anticipated by the operator and appropriate avoidance measures manually implemented. However, in some situations, rollover may be difficult for the operator to anticipate and, without suitable automated safety measures in place, rollover may be unavoidable. This rollover potential may be even greater when the machine is remotely, autonomously, or semi-autonomously controlled.

Remotely controlled, autonomously controlled, and semi-autonomously controlled machines are capable of operating with little or no human input by relying on information received from various machine systems. For example, based on machine movement input, terrain input, and/or machine operational input, a machine can be controlled to remotely and/or automatically complete a programmed task. By receiving appropriate feedback from each of the different machine systems during performance of the task, continuous adjustments to machine operation can be made that help to ensure precision and safety in completion of the task. In order to do so, however, the information provided by the different machine systems should be accurate and reliable. For example, a determined inclination angle of the machine should be accurate at all times, even when the machine is experiencing vibrations. However, some inclinometers drift off from the real inclination angle value when encountering certain vibrations.

An exemplary system that may be used to correct error in the measurement of an inclination angle of a machine is disclosed in U.S. Pat. No. 7,873,458 to Todd that issued on Jan. 18, 2011 (“the '458 patent). The system of the '458 patent is capable of determining the inclination angle of a machine using an output from a pendulum device based on the deflection of the pendulum's arm. Error in the measured inclination angle due to sudden vehicle acceleration can be corrected for by measuring the tension in the arm due to inherent effects of vehicle acceleration on the pendulum's suspended mass.

Although the system of the '458 patent may be useful for correcting an error in the measurement of the inclination angle of a machine due to sudden acceleration of the machine, the system does not address error in the measurement of the inclination angle that may occur due to vibrations. Thus, if vibrations occur during the course of machine operation, the system of the '458 patent may generate incorrect inclination angle measurements.

The disclosed inclination determination system is directed to overcoming one or more of the problems set forth above and/or other problems of the prior art.

### SUMMARY

In one aspect, the present disclosure is directed to an inclination angle determination system for determining an inclination angle of a machine. The system may include an inclinometer, an accelerometer, and a controller. The controller may be configured to determine the inclination angle of the machine based on input from the inclinometer and accelerometer. For example, the controller may receive inclination data from the inclinometer and may also receive derived inclination data based on acceleration data from the accelerometer. The controller may compare the inclination data and the derived inclination data, and may determine which of the inclination data and the derived inclination data to use as the inclination angle of the machine based on the comparison.

In another aspect, the present disclosure is directed to a computer-implemented method of determining an inclination angle of a machine. The method may include receiving inclination data from an inclinometer and receiving derived inclination data based on acceleration data from the accelerometer. The method may compare the inclination data and the derived inclination data and may determine which of the inclination data and the derived inclination data to use as the inclination angle of the machine based on the comparison.

### BRIEF DESCRIPTION OF THE DRAWINGS

FIG. 1 is a pictorial illustration of an exemplary disclosed machine;

FIG. 2 is a diagrammatic illustration of an exemplary disclosed inclination determination system that may be used in conjunction with the machine of FIG. 1; and

FIG. 3 is a flowchart depicting an exemplary disclosed method that may be performed by the system of FIG. 2.

### DETAILED DESCRIPTION

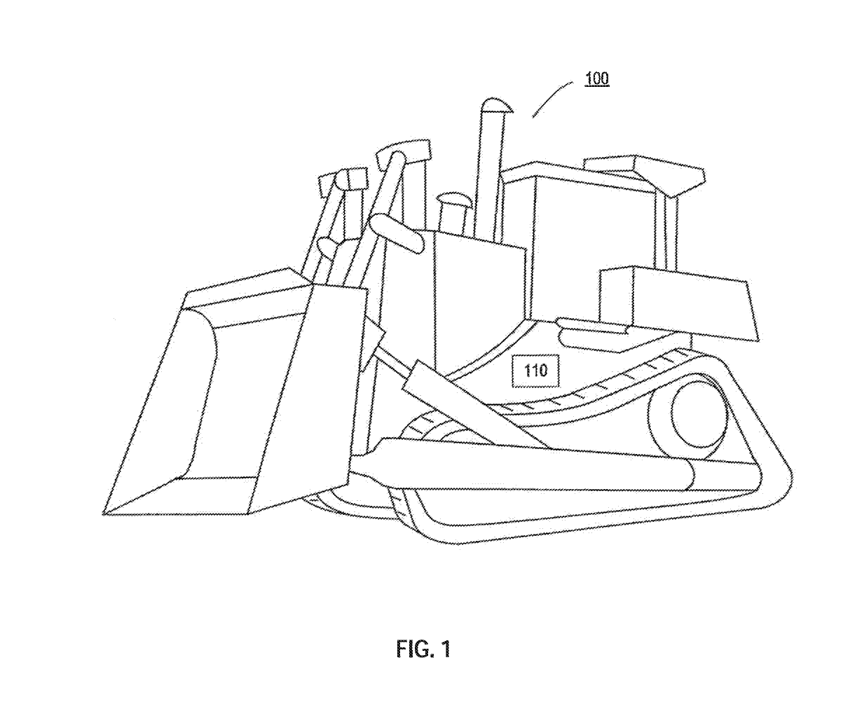

FIG. 1 illustrates a machine 100 having an exemplary disclosed inclination angle determination system 110. Machine 100 may embody a machine configured to perform some type of operation associated with an industry such as mining, construction, farming, transportation, power generation, or any other industry known in the art. For example, machine 100 may be an earth moving machine such as a haul truck, a dozer, a loader, a backhoe, an excavator, a motor grader, a wheel tractor scraper, or any other earth moving machine.

Inclination angle determination system 110 may include components that gather information from machine 100 during operation of machine 100. For example, inclination angle determination system 110 may include various sensors, e.g., accelerometers, inclinometers, gyroscopes, global positioning system (GPS) devices, radar devices, etc., that may be used to measure, e.g., location, horizontal, vertical, and forward velocities and accelerations, inclination angle (e.g., pitch, roll), inclination angular rate, heading, yaw rate, etc. Inclination angle determination system 110 may also include any combination of hardware and/or software capable of executing one or more computer programs that may include algorithms, e.g., an inclination determination algorithm, an inclination angle correction algorithm, a Kalman filter algorithm, etc., to process the measurements made by the various sensors.

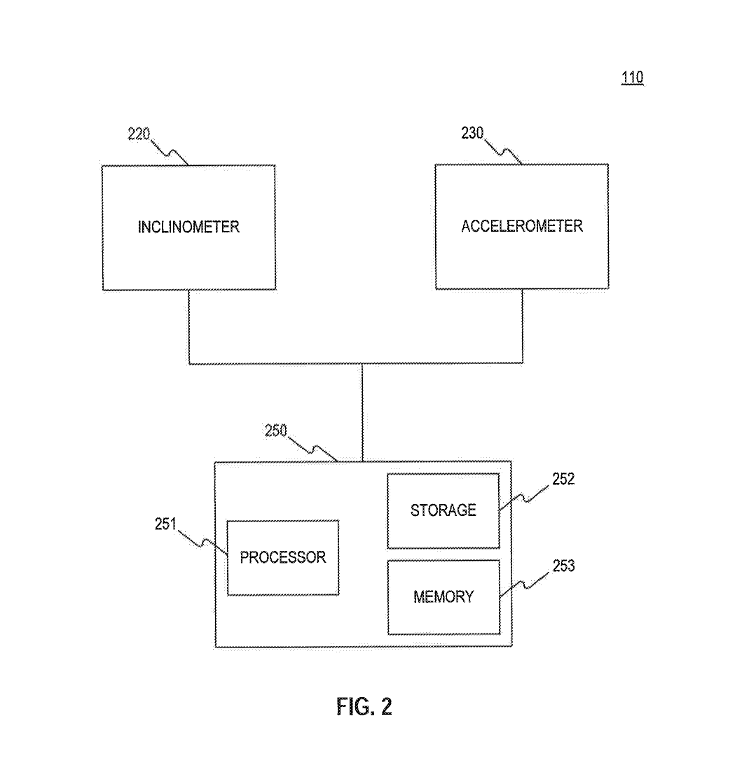

FIG. 2 illustrates an exemplary inclination angle determination system 110 that may be used in conjunction with machine 100. Inclination angle determination system 110 may include an inclinometer 220, an accelerometer 230, and a controller 250. While a bus architecture is shown in FIG. 2, any suitable architecture may be used, including any combination of wired and/or wireless networks. Additionally, such networks may be integrated into any local area network, wide area network, and/or the Internet.

In certain embodiments, inclinometer 220 may be a high accuracy MEMS inclinometer. As discussed above, vibrations in machine 100 may lead to inaccurate inclinometer measurements. For example, inclinometer 220 may produce an offset in its output when under certain vibrations, resulting in an erroneous measurement of the inclination of machine 100. Accelerometer 230 may be part of the same IMU that contains inclinometer 220, or may be a separate device. The two sensors may have different frequency responses and may sense vibrations differently. Therefore, there may often be a substantial difference between the two raw sensor outputs when the system is under vibration. Accelerometer 230 may not drift as much as inclinometer 220 under certain vibrations. Accelerometer 230 may be as accurate as inclinometer 220 should be during vibration conditions, but may have a lower resolution. Therefore, in some embodiments, it may be generally preferred to use inclinometer 220 whenever possible, since inclinometer 220 may be more accurate and have a higher resolution than accelerometer 230 under most conditions. But, it may sometimes be necessary to depend on accelerometer 230 when inclinometer 220's reading is inaccurate. Consistent with embodiments discussed in greater detail below, controller 250 may determine whether to use the data from inclinometer 220 or the data from accelerometer 230 when determining the inclination angle of machine 100.

Controller 250 may include processor 251, storage 252, and memory 253, included together in a single device and/or provided separately. Processor 251 may include one or more known processing devices, such as a microprocessor from the Pentium™ or Xeon™ family manufactured by Intel™, the Turion™ family manufactured by AMD™, or any other type of processor. Memory 253 may include one or more storage devices configured to store information used by controller 250 to perform certain functions related to the disclosed embodiments. Storage 252 may include a volatile or non-volatile, magnetic, semiconductor, tape, optical, removable, non-removable, or other type of storage device or computer-readable medium. Storage 252 may store programs and/or other information, such as information related to processing data received from one or more sensors, as discussed in greater detail below.

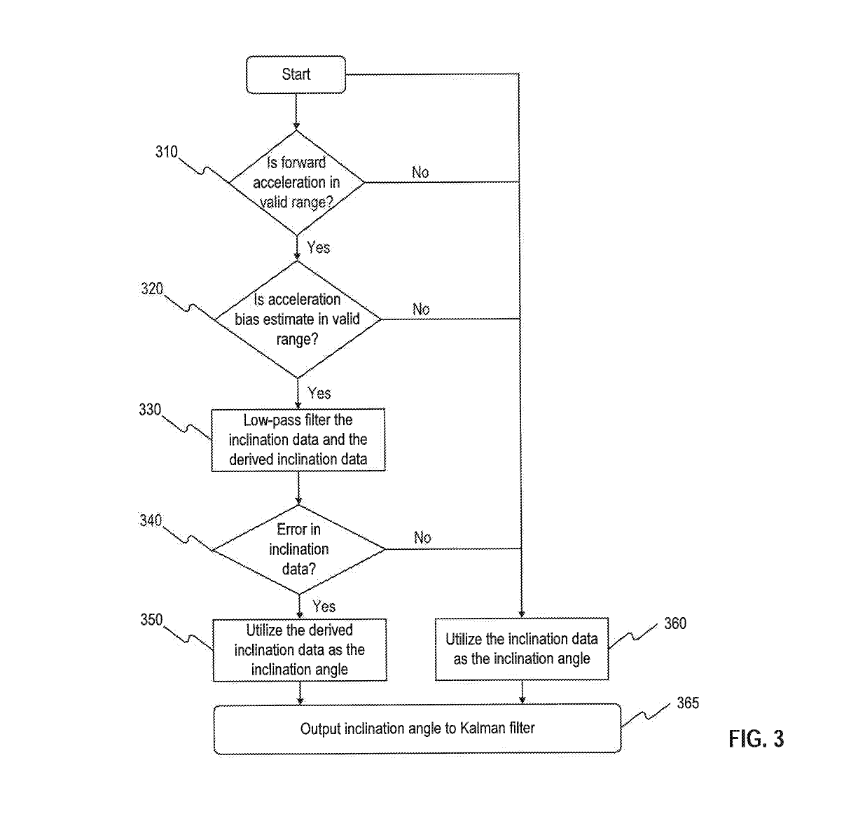

in one embodiment, memory 253 may include one or more inclination angle determination programs or subprograms loaded from storage 252 or elsewhere that, when executed by processor 251, perform various procedures, operations, or processes consistent with the disclosed embodiments. For example, memory 253 may include one or more programs that enable controller 250 to, among other things, collect data from inclinometer 220 and accelerometer 230, process the data according to disclosed embodiments such as those embodiments discussed with regard to FIG. 3, and determine an inclination angle of machine 100 based on the processed data.

In certain embodiments, memory 253 may include a program enabling controller 250 to process data using a Kalman filter. A Kalman filter is a mathematical method that may be used to determine accurate values of measurements observed over time, such as measurements taken in a time series. In various embodiments, once a determination is made as to which sensor's (inclinometer 220 or accelerometer 230) inclination data is to be used, the data may be input as the inclination angle of machine 100 into a Kalman filter for other processes in accordance with known methods.

In some embodiments, the Kalman filter may include a prediction step, performed by a prediction module, and an update step, performed by an update module. In a given time-step, the prediction step may include estimating a value for a parameter of interest, for example, inclination angle. The estimated value may be based on several estimated values generated by the update module in a previous time-step, as well as on measured values. For example, the prediction module may generate an estimated inclination angle based on a previously estimated inclination angle and a previously estimated inclination angular rate bias, as determined by the update module in the previous time-step, as well as a measured inclination angular rate. In various embodiments, after the prediction module generates an estimated value, the update module may utilize that estimated value to generate new estimations. For example, after the prediction module generates an estimated inclination angle, the update module may utilize the prediction module's estimated inclination angle, along with a current value of the inclination angle based on measurements and a measurement variance, to generate an inclination angle estimate (which the prediction module may use in a following time-step), an inclination angular rate estimate, and a bias estimate for both the inclination angle and inclination angular rate (which the prediction module may use in a following time-step). In some embodiments, the current value of the inclination angle based on measurements may come from inclination angle determination system 110.

FIG. 3 illustrates an exemplary method that may be performed by controller 250, e.g., by executing one or more instructions stored on a computer readable medium such as storage 252 and/or memory 253, to determine an inclination angle of machine 100. FIG. 3 will be discussed in more detail in the following section to further illustrate the disclosed concepts.

### INDUSTRIAL APPLICABILITY

The disclosed inclination angle determination system 110 may be applicable to any machine, such as e.g., machine 100, where accurate determination of the machine's inclination angle is desired. The inclination angle may refer to an angle of inclination of machine 100 about any axis. For example, the inclination angle may refer to a pitch angle, a roll angle, or a combination of the two, where the pitch angle is the angle of rotation about an axis extending from the left side to the right side of machine 100, and the roll angle is the angle of rotation about an axis extending from the front side to back side of machine 100.

The disclosed inclination angle determination system 110 may provide for improved determination of machine 100's inclination angle through the use of inclination data from inclinometer 220 and acceleration data from accelerometer 230. The acceleration data from accelerometer 230 may be used to calculate derived inclination data. This derived inclination data may be based on the arcsine of acceleration, as measured by accelerometer 230, divided by the magnitude of the acceleration due to gravity. For example, the derived inclination data may be calculated to be:

$${i}_{d} = {sin}^{- 1} ( \frac{a}{g} ) \qquad ( 1 )$$

where i_{d} is the derived inclination and a is the acceleration measured by accelerometer 230 in units of

$$[ \frac{m}{{s}^{2}} ] .$$

Alternatively, the derived inclination data may be based on the arcsine of a compensated acceleration (e.g., acceleration minus an acceleration bias estimate) divided by the magnitude of acceleration due to gravity, where the acceleration is that as measured by accelerometer 230 and the acceleration bias estimate is calculated by various methods. The derived inclination data, for example, may be calculated to be:

$${i}_{d} = {sin}^{- 1} ( \frac{a - {β}_{a}}{g} ) \qquad ( 2 )$$

where i_{d} is the derived inclination, a is the acceleration measured by accelerometer 230 in units of

$$[ \frac{m}{{s}^{2}} ] ,$$

βₐ is the acceleration bias estimate in units of

$$[ \frac{m}{{s}^{2}} ] ,$$

and g is gravity in units of

$$[ \frac{m}{{s}^{2}} ] .$$

The acceleration bias estimate accounts for a portion of the output signal from accelerometer 230 which persists even when no acceleration is present (not including gravity). The acceleration bias estimate may be determined by various methods known in the art. For example, the acceleration bias may be calculated by experimentation, where a known acceleration is measured and subtracted from the acceleration as measured by accelerometer 230. Alternatively, the acceleration bias may be obtained as an output from a Kalman filter process, such as the one described above, but in which the parameter being estimated is velocity, instead of inclination angle. This Kalman filter may receive a measured acceleration from accelerometer 230 as one of the inputs and output an estimate of acceleration bias. This acceleration bias estimate can then be used to compensate the acceleration measured by accelerometer 230, according to the equation for compensated acceleration described above. In some embodiments, the compensated acceleration may be preferred over the uncompensated acceleration for greater accuracy when calculating the derived inclination data from accelerometer 230.

During operation of inclination angle determination system 110, controller 250 may receive signals from inclinometer 220 and accelerometer 230. In some embodiments, inclination angle determination system 110 may determine whether the forward acceleration measured by accelerometer 230 is in a valid range (Step 310), to determine that the accelerometer 230 is not malfunctioning. In some embodiments, the valid range may be between −1 g and 1 g, since the arcsine function is not valid for magnitudes greater than 1. If the acceleration is not in a valid range (Step 310, No), the inclination angle determination system 110 may utilize inclinometer 220's inclination data as the inclination angle of machine 100 (Step 360). This inclination angle may be output to another process which may utilize the inclination angle. In one exemplary embodiment, the inclination angle may be output to a Kalman filter (Step 365).

If the forward acceleration received from accelerometer 230 is in a valid range (Step 310, Yes), inclination angle determination system 110 may determine whether an acceleration bias estimate is in a valid range (Step 320). As discussed earlier, the acceleration bias estimate is used to calculate a compensated acceleration from accelerometer 230, which may produce a more accurate derived inclination data. Inclination angle determination system 110 may determine if the acceleration bias estimate is in a valid range by using a Kalman filter, a high pass filter method, a low-pass filter, or other methods known in the art. In some embodiments, the valid range may be based on the device specifications of accelerometer 230. If the acceleration bias estimate is not in a valid range (Step 320, No), it may be an indication that accelerometer 230 is not functioning properly, and inclination angle determination system 110 may proceed to Step 360 and utilize the inclination data from inclinometer 220 as the inclination angle of machine 100.

If the acceleration bias estimate is within a valid range (Step 320, Yes), inclination determination system 110 may low-pass filter the inclination data from inclinometer 220 and the derived inclination data from accelerometer 230 (Step 330). In some embodiments, the low-pass filter may be an IIR filter or a moving average filter. In certain embodiments, the low-pass filter may have a cut-off frequency that is equal to or lower than the lowest frequency at which either inclinometer 220 or accelerometer 230 can respond. Under vibration conditions in which inclinometer 220 does not produce an erroneous inclination signal, the results of low-pass filtering the inclination data and the derived inclination data should not diverge from each other by more than a threshold difference value.

In various embodiments, in order to determine which sensor signal to use as the inclination angle of machine 100, inclination angle determination system 110 may determine whether there is an error in the inclination data (Step 340), e.g., by calculating a difference between the inclination data from inclinometer 220 and the derived inclination data from accelerometer 230. In some embodiments, if the difference between the low-pass filtered inclination data from inclinometer 220 and the low-pass filtered derived inclination data from accelerometer 230 is less than or equal to a threshold difference value, inclination angle determination system 110 may determine that an error does not exist (Step 340, No) and may utilize the inclination data from inclinometer 220 as the inclination angle of machine 100 (Step 360). However, in some embodiments, if the difference between the low-pass filtered inclination as measured by inclinometer 220 and the low-pass filtered inclination as derived by accelerometer 230 is greater than the threshold difference value, inclination angle determination system 110 may determine that an error does exist (Step 340, Yes) and may utilize the derived inclination from accelerometer 230 as the inclination angle of machine 100 (Step 350). In some embodiments, the threshold difference may be, for example, 1 degree. In various embodiments, after inclination angle determination system 110 sets either the derived inclination data or the inclination data as the inclination angle, inclination angle determination system 110 may output the inclination angle to other processes. For example, inclination angle determination system 110 may output the inclination angle to a Kalman filter (Step 365). In some embodiments, when the difference between the two sensor data becomes smaller than the threshold difference value, inclination angle determination system 110 may start utilizing the inclination data from inclinometer 220 as the inclination angle of machine 100 again.

In some embodiments, when the inclination angle is output to a Kalman filter (Step 365), the Kalman filter may use this inclination angle as a measured input value in conjunction with estimated input values, e.g., an estimated inclination angle from a prediction module of the Kalman filter, to generate a revised estimated value e.g., a revised estimated inclination angle of machine 100. The Kalman filter may use the generated revised estimated inclination angle in compensating the measured inclination angle of machine 100.

The disclosed inclination angle determination system may allow for accurate measurement of inclination angles. In particular, the system may allow for accurate determination of inclination angles even under certain vibration conditions. More accurate measurement of the inclination angle may aid in the safe operation of the machine.

It will be apparent to those skilled in the art that various modifications and variations can be made to the disclosed inclination angle determination system. Other embodiments will be apparent to those skilled in the art from consideration of the specification and practice of the disclosed inclination angle determination system. It is intended that the specification and examples be considered as exemplary only, with a true scope being indicated by the following claims and their equivalents.

What is claimed is:

1. An inclination angle determination system for determining an inclination angle of a machine comprising:
an inclinometer;
an accelerometer; and
a controller configured to determine the inclination angle by:
receiving inclination data from the inclinometer;
receiving derived inclination data based on acceleration data from the accelerometer;
comparing the inclination data and the derived inclination data; and
determining which of the inclination data and the derived inclination data to use as the inclination angle of the machine based on the comparison.

2. The system according to claim 1, wherein comparing the inclination data and the derived inclination data includes:
applying a low-pass filter on the inclination data and the derived inclination data; and
calculating a difference between the low-pass filtered inclination data and the low-pass filtered derived inclination data.

3. The system according to claim 2, wherein determining which of the inclination data and the derived inclination data to use includes:
using the inclination data as the inclination angle of the machine, when the difference is less than or equal to a threshold difference value; and
using the derived inclination data as the inclination angle of the machine, when the difference is greater than the threshold difference value.

4. The system according to claim 3, wherein determining which of the inclination data and the derived inclination data to use includes:
determining whether a forward acceleration received from the accelerometer is in a valid range; and
using the inclination data from the inclinometer as the inclination angle of the machine, when the forward acceleration is outside the valid range.

5. The system according to claim 3, wherein the derived inclination data is a compensated derived inclination data, which has been adjusted for an acceleration bias estimate.

6. The system according to claim 5, wherein determining which of the inclination data and the derived inclination data to use includes:
determining whether the acceleration bias estimate is in a valid range; and
using the inclination data from the inclinometer as the inclination angle of the machine, when the acceleration bias estimate is outside the valid range.

7. The system according to claim 1, wherein the inclination angle is provided as an input to a Kalman filter process.

8. The system according to claim 3, wherein when the derived inclination data is used as the inclination angle of the machine, the controller changes the inclination angle of the machine to be the inclination data once the difference falls below the threshold difference value.

9. A computer-implemented method of determining an inclination angle of a machine comprising:
receiving inclination data from an inclinometer;
receiving derived inclination data based on acceleration data from an accelerometer;
comparing the inclination data and the derived inclination data; and
determining which of the inclination data and the derived inclination data to use as the inclination angle of the machine based on the comparison.

10. The computer-implemented method according to claim 9, wherein comparing the inclination data and the derived inclination data includes:
applying a low-pass filter on the inclination data and the derived inclination data; and
calculating a difference between the low-pass filtered inclination data and the low-pass filtered derived inclination data.

11. The computer-implemented method according to claim 10, wherein determining which of the inclination data and the derived inclination data to use includes:
using the inclination data as the inclination angle of the machine, when the difference is less than or equal to a threshold difference value; and
using the derived inclination data as the inclination angle of the machine, when the difference is greater than the threshold difference value.

12. The computer-implemented method according to claim 11, wherein determining which of the inclination data and the derived inclination data to use includes:
determining whether a forward acceleration received from the accelerometer is in a valid range; and
using the inclination data from the inclinometer as the inclination angle of the machine, when the forward acceleration is outside the valid range.

13. The computer-implemented method according to claim 11, wherein the derived inclination data is a compensated derived inclination data, which has been adjusted for an acceleration bias estimate.

14. The computer-implemented method according to claim. 13, wherein determining which of the inclination data and the derived inclination data to use includes:
determining whether the acceleration bias estimate is in a valid range; and
using the inclination data from the inclinometer as the inclination angle of the machine, when the acceleration bias estimate is outside the valid range.

15. The computer-implemented method according to claim 9, wherein the inclination angle is provided as an input to a Kalman filter process.

16. The computer-implemented method according to claim 11, wherein when the derived inclination data is used as the inclination angle of the machine, the inclination angle of the machine is changed to be the inclination data once the difference falls below the threshold difference value.

17. A system for determining an inclination angle of a machine, comprising:
one or more memories storing instructions; and
one or more processors configured to execute instructions to perform:
receiving inclination data from an inclinometer;
receiving acceleration data from an accelerometer;
calculating derived inclination data based on the acceleration data;
comparing the inclination data and the derived inclination data; and
outputting, to a controller of the machine, one of the inclination data or the derived inclination data as the inclination angle of the machine based on the comparison.

18. The system according to claim 17, wherein comparing the inclination data and the derived inclination data includes:
applying a low-pass filter on the inclination data and the derived inclination data; and
calculating a difference between the low-pass filtered inclination data and the low-pass filtered derived inclination data.

19. The system according to claim 18, wherein determining which of the inclination data and the derived inclination data to output includes:
outputting the inclination data as the inclination angle of the machine, when the difference is less than or equal to a threshold difference value; and
outputting the derived inclination data as the inclination angle of the machine, when the difference is greater than the threshold difference value.

20. The system according to claim 19, wherein
the controller of the machine includes a Kalman filter for generating a revised estimated inclination angle of the machine based on a measured inclination angle of the machine, and
the one or more processors is further configured to execute instructions to output the inclination angle of the machine as the measured inclination angle of the machine to the Kalman filter for use in generating the revised estimated inclination angle of the machine.
